(19) United States
(12) Patent Application Publication
(10) Pub. No.: US 2006/0050892 A1
(43) Pub. Date: Mar. 9, 2006

(54) Audio-visual system and tuning method therefor

(75) Inventors: Byung-cheol Song, Suwon-si (KR); Kang-wook Chun, Hwaseong-si (KR); Jae-Chol Lee, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/207,848

(22) Filed: Aug. 22, 2005

(30) Foreign Application Priority Data
Sep. 6, 2004 (KR) 10-2004-0070819

(51) Int. Cl. H04R 29/00; H04B 1/20

(52) U.S. Cl. 381/59; 340/825.25; 381/58; 381/104

(57) ABSTRACT

An audio-visual (AV) system and timing method senses the location of a user and provides optimum sound quality. The tuning method for the AV system includes: sensing the location of an electronic apparatus located within a predetermined close distance from a user and calculating the direction and distance from the electronic apparatus to at least one speaker; and by regarding the sensed location of the electronic apparatus as the location of the user and based on the calculated direction and distance information calculated, adjusting the direction and volume of each speaker in order to provide optimum sound quality to the location of the user. Accordingly, with respect to the changing location of the user, optimum sound quality can be provided.

### CROSS-REFERENCE TO RELATED APPLICATION

This application claims the benefit of Korean Patent Application No. 10-2004-0070819, filed on Sep. 6, 2004, in the Korean Intellectual Property Office, the disclosure of which is incorporated herein in its entirety by reference.

### BACKGROUND OF THE INVENTION

1. Field of the Invention

The present invention relates to an audio-visual (AV) system, and more particularly, to a method of tuning an AV system so that the location of a user is sensed and optimum sound quality is provided to the user, and an AV system using the method.

2. Description of the Related Art

Recently, digital AV appliances including DVD players, home theater systems, and large-sized digital TVs have been widely provided. In particular, the home theater system providing a theater like atmosphere at home has been gaining popularity. The home theater system includes video appliances such as a projector, a projection system, a PDP, and a digital TV, an AV decoder supporting a digital theater system (hereinafter referred to as a “DTS”) with at least 5.1 channels and Dolby digital (hereinafter referred to as “DD”), and a speaker system with 5.1 channel or more. As such, viewers can enjoy even at home clear images and splendid sound like in a theater.

FIG. 1 is a diagram showing a structure of a conventional home theater system as an example of an AV system. Referring to FIG. 1, a conventional home theater system includes video appliances such as a digital TV, an AV decoder and amplifier, and a speaker system. The speaker system is formed with a left front speaker (LFS), a right front speaker (RFS), a center speaker (CS), a left surround speaker (LSS), a right surround speaker (RSS), and a subwoofer to provide 5.1-channel sound. That is, in the case of the basic 5.1 channels, the system is formed with 1 center speaker channel, 2 front speaker channels, 2 surround speaker channels, and 0.1 subwoofer speaker channel. Speaker systems with 6.1 channels and 7.1 channels have been developed recently.

Among the component modules forming a home theater, the AV decoder plays one of the most important roles. The AV decoder performs a decoding function decoding a moving picture stream and digital sound included in a DVD title. Generally, a DVD title supports multi-channel sound of 5.1 channels or more in addition to 2 channel digital sound. Representative examples are Dolby digital (DD) and the DTS mentioned above. In order to enjoy movies or music at home with a theater-level multi-channel digital sound, a digital signal should be received through a digital cable such as a coaxial cable or a fiber cable, decoded by a latest AV decoder having a DD or DTS decoding capability, separated into 5.1 channels or more amplified, and then output through speakers. In order to offer a vivid sound, the quality of the speaker system is important.

A speaker system capable of offering surround sound is generally formed with left and right front speakers, a center speaker, and left and right surround speakers. When a subwoofer for strong bass sound is added, the system becomes a 5.1-channel digital sound system that is referred to as a Dolby system. The front speakers perform a basic role of providing a general sound effect. The center speaker is for most dialogs as well as for general sound effects together with the front speakers. Depending on the setting of the center speaker, the sound of a movie can vary. In the case of surround speakers, the size does not need to be large, and the speakers are important because they increase a realistic effect of a movie by directing the sound to a user. For the surround speakers, the installation location and direction are very important. The subwoofer is not an essential element to form a home theater system, and is a speaker reproducing strong bass sound. An active subwoofer with an embedded amplifier, is generally employed, but there is also a passive subwoofer requiring a separate amplifier.

In particular, the speaker's arrangement to determine how to arrange the speakers is very important. While the speaker's setting depends much on the structure of a place where the home theater system is installed, even in an identical structure, a provided sound field varies with respect to the distance between the speakers and the directions of speakers. The sound field means the acoustic characteristic of a space.

Each of a theater, a concert hall, and a house living room has a different structure and size, and accordingly, has a characteristic sound field. The theater has a variety of conditions capable of providing a large, colossal, and transparent image. However, the house has obstacles such as furniture and decoration. Accordingly, it is unlikely for a house to generate the same cubic image that can be felt in the theater. As a result, most of the AV decoders and/or amplifiers have a function (DSP) of virtually producing a sound field. The function virtually reproduces the sound field of a particular location such as a theater, a live hall, a huge stadium, a church, or a famous jazz club, having totally different acoustic characteristics from that of a house, and causes an illusion that the user is in such a location. The generation of a sound field is accompanied by a very complicated process. The acoustic characteristic of a space desired to be reproduced is measured, and the original sound is processed to fit the characteristic and generated as totally different sound.

In order to reproduce a good sound field, it is most important to arrange the speakers at appropriate places. Referring to FIG. 1, a most general speakers' setting to enjoy 5.1 channels correctly is shown. That is, assuming that the user is located in the center directly in front of the display apparatus, the direction or volume of speakers are adjusted. If the user moves frequently, the user cannot enjoy the set optimum sound quality. This is because the user moves from the optimum location in the sound field.

In order to solve this problem, a system identifying the location of a user and adjusting the direction and volume of each speaker to fit the current location of the user has been under development. At this time, the core problem is how to determine the location of the user. As a leading solution to this problem, there is a method using pattern recognition technology. That is, a camera is installed on a TV, moving pictures are captured from the front of the TV to extract the face or pupils of a human being, and based on the extraction result, the location of the user is determined.

However, the problem of this method is that the pattern recognition technology known so far is not perfect. Though the pupil recognition technology or face recognition technology has been studied in the artificial intelligence field for decades, there are no technologies so far that can identify perfectly a specific person.

### SUMMARY OF THE INVENTION

The present invention provides an audio-visual (AV) system sensing the location of a user and providing optimum sound quality, and a tuning method therefor. According to an aspect of the present invention, there is provided a tuning method for an audio-visual (AV) system, including: sensing the location of an electronic apparatus located within a predetermined close distance from a user and calculating the direction and distance from the electronic apparatus to at least one speaker; and based on the sensed location of the electronic apparatus as the location of the user and based on the calculated direction and calculated distance information of the electronic apparatus, adjusting the direction and volume of each speaker in order to provide optimum sound quality to the user.

The electronic apparatus may be any apparatus that can be attached to the body of the user, such as a remote controller, a necklace, a wrist watch, a badge having a sensor, or an index tag having a sensor based on an electromechanical system (MEMS).

In order to sense the location of the electronic apparatus, the sensing is performed by a laser sensor, an infrared sensor, an ultrasound sensor, or a radio frequency identification (RFID) sensor used in a wireless barcode system, may be used.

The calculating of the direction and distance may include: if a directional sensor is used, drawing virtual lines in the sensed direction from the center of each speaker, determining the intersection of the virtual lines as the location of the electronic apparatus, and calculating the distance.

The calculating of the direction and distance may include: if a distance sensor is used, drawing circles having the centers of the speakers as respective circle centers and the sensed distances as respective radiuses, determining the intersection of all the circles as the location of the remote controller, and calculating the direction.

In the adjusting of the direction and volume of each speaker, the direction of the speaker may be adjusted to be perpendicular to the calculated direction, and based on the calculated distance, the volume is adjusted.

The method may further include: adjusting the direction of a display apparatus based on the calculated direction and distance information.

In adjusting the direction of the display apparatus, the direction of the display apparatus may be adjusted to be perpendicular to the calculated direction.

According to another aspect of the present invention, there is provided an AV system including: an AV decoder decoding video data and audio data; at least one speaker to output the decoded audio data; and an electronic apparatus located within a predetermined distance from a user, wherein a sensor sensing the location of the electronic apparatus is attached to each speaker, and the speaker has a control unit adjusting the direction and volume of the speaker such that using information sensed through the sensor, the direction and distance of the electronic apparatus to a corresponding speaker area calculated and based on the calculated direction and distance, optimum sound quality is be provided.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram showing a structure of a conventional home theater system as an example of an audio-visual (AV) system;

FIG. 2 is a diagram showing the structure of an AV system sensing the location of a user and providing optimum sound quality according to an embodiment of the present invention;

FIG. 3 is a block diagram of a speaker sensing the location of a user and providing optimum sound quality according to the present invention;

FIG. 4 is a diagram for explaining a method of adjusting the direction and volume of a speaker in a home theater system according to another embodiment of the present invention;

FIG. 5 is a diagram for explaining a method of calculating the distance when there is only a direction sensor according to an embodiment of the present invention;

FIG. 6 is a diagram for explaining a method of calculating the direction when there is only a distance sensor, according to another embodiment of the present invention;

FIG. 7 is a diagram for explaining a method of sensing a remote controller and adjusting the direction of a display apparatus according to another embodiment of the present invention; and

FIG. 8 is a flowchart of operations of a method of sensing the location of a user and tuning an AV system according to the present invention.

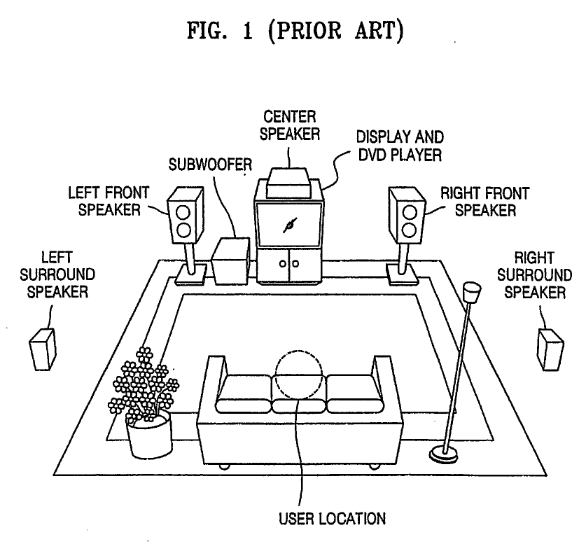

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

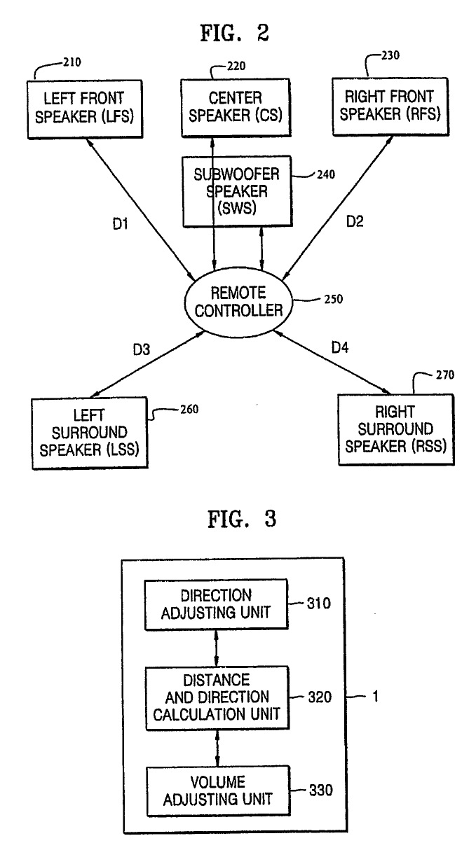

Referring to FIG. 2, the AV system according to the present invention includes a speaker system, formed with left and right front speakers (210, 230), a center speaker (220), and left and right surround speakers (260, 270), an AV decoder (not shown), and an electronic apparatus (250) with a sensor attached for sensing the location of a user.

According to an aspect of the present embodiment, an example of a remote controller will be explained as an example of the electronic apparatus with a sensor attached for sensing the location of a user.

All future digital appliances as well as most existing digital appliances may have a remote controller. Generally, a user using an AV system such as a home theatre always holds a remote controller in the hand or puts it nearby. Accordingly, sensing the remote controller will have the same effect as sensing the location of the user.

In addition, as an electronics apparatus with a sensor attached for sensing the location of a user, apparatuses that have an attached sensor and can be attached to the body of a user, such as a necklace, a wrist watch, a badge, or an index tag based on a micro electro-mechanical system (MEMS) can be used. Also, in order to sense the location of the electronic apparatus, a sensor such as a laser sensor, an infrared sensor, an ultrasonic sensor, or a radio frequency identification (RFID) sensor can be used.

According to an aspect of the present invention a sensor sensing the location of the electronic apparatus is attached to a speaker, and each speaker has a control unit adjusting the direction and volume of the speaker such that using information sensed through the sensor, the direction and distance of the electronic apparatus to a corresponding speaker are calculated, and based on the calculated direction and distance, optimum sound quality can be provided.

FIG. 3 is a block diagram of a speaker sensing the location of a user and providing optimum sound quality according to an aspect of the present invention. Referring to FIG. 3, the speaker 1 includes a distance and/or direction calculation unit 320, a direction adjusting unit 310, and a volume adjusting unit 330. These can be referred to collectively as the control unit of the speaker.

The distance and/or direction calculation unit 320 senses the electronic apparatus described above and calculates the distance and direction of the speaker. That is, by using the sensor included in the electronic apparatus, the distance or direction of the speaker and the electronic apparatus is sensed. Depending on the type of the sensor, if the distance is sensed, the direction can be calculated by using the distance, and reversely, if the direction is sensed, the distance can be calculated by using the direction. Depending on the type of the sensor, if both the distance and direction are sensed, additional calculation may not be needed. The method of calculating the distance or direction will be explained later.

The direction adjusting unit 310 adjusts the direction of the speaker by using the distance and direction information calculated in the distance and/or direction calculation unit 320. The direction of the speaker corresponds to the calculated direction of the electronic apparatus. For this, the speaker has an embedded electric direction adjusting apparatus (320) and a volume adjusting apparatus (330).

Based on the structure of the speaker described above, an example of a tuning operation of an AV system according to the present invention will now be explained. The user pushes a predetermined button such as power-on of the remote controller. In a state where the power is on, the remote controller and the AV system interact with each other automatically and continuously. Each speaker senses the remote controller as described with reference to FIG. 3, and calculates the distance and direction of the remote controller. The direction and volume of the speaker are adjusted to fit the calculated direction and distance (D1, D2, D3, and D4 of FIG. 2). Identical operations are performed in all speakers. Even when the user moves, each speaker continuously identifies the location and direction of the remote controller and adjusts the direction and volume of the speaker to provide optimum sound quality. Accordingly, with respect to the changing location of the user, the AV system can be tuned to provide optimum sound quality.

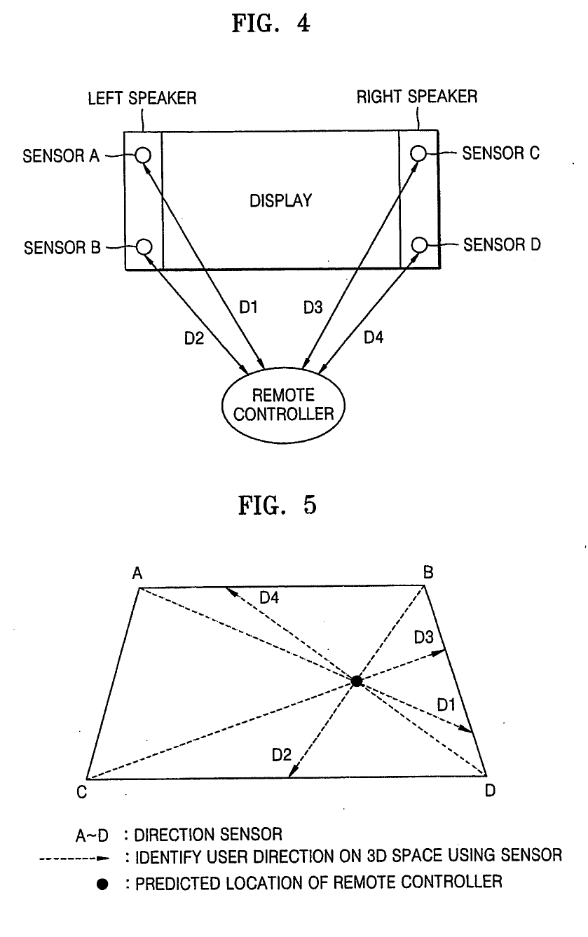

FIG. 4 is a diagram for explaining a method of adjusting the direction and volume of a speaker in a home theater system according to another embodiment of the present invention. The present invention can be applied even to a TV set. Referring to FIG. 4, it is assumed that the speakers of the home theater system are directional speakers and each of left and right side speakers have a sensor sensing an electronic apparatus such as a remote controller. As an embodiment, if a plurality of sensors is used as in FIG. 4, the 3-dimensional location of an electronic apparatus can be identified. According to the identified location of the electronic apparatus, the direction and volume of each speaker can be adjusted. An embodiment of an operation for tuning the TV according to the present invention will now be explained.

The user pushes a predetermined button such as power-on of the remote controller. In a state where the power is on, the remote controller and the AV system interact with each other automatically and continuously. Each speaker senses the remote controller as described with reference to FIG. 4, and calculates the distance and direction of the remote controller. The direction and volume of the speaker are adjusted to fit the calculated direction and distance (D1, D2, D3, and D4 of FIG. 4). Identical operations are performed in all speakers. Even when the user moves, each speaker continuously identifies the location and direction of the remote controller and adjusts the direction and volume of the speaker to provide optimum sound quality. Accordingly, with respect to the changing location of the user, the TV set can be tuned to provide optimum sound quality.

Meanwhile, in case of a floor standing speaker, the location can be adjusted by using an electric apparatus. Accordingly, it is also possible to adjust the location of the floor standing speaker with respect to the direction and distance of the remote controller.

FIG. 5 is a diagram for explaining a method of calculating the distance when there is only a direction sensor according to an embodiment of the present invention. Referring to FIG. 5, first, it is assumed that the location of each speaker is known beforehand. If a virtual line is drawn from the center of each of at least two or more speakers in the direction where the electronic apparatus is sensed, there will be an intersection, which will be the location of the electronic apparatus such as a remote controller. If it is assumed that the absolute location of each speaker is already known, once the absolute coordinates of the remote controller is obtained, the distance between the remote controller and each speaker can be calculated at the same time.

For example, assuming that the 3-dimensional absolute coordinates of speaker A are (X_{A}, Y_{A}, Z_{A}) and the absolute coordinates of the remote controller obtained by the method described above are (X_{R}, Y_{R}, Z_{R}), distance d of speaker A and remote controller R can be calculated by the following equation 1:
d=\sqrt{(X_{A}−X_{R})²+(Y_{A}−Y_{R})²+(Z_{A}−Z_{R})²} (1)

Though an example of the speaker having the distance and/or direction calculation unit is explained in the present embodiment, the distance and/or direction calculation unit can be installed in the remote controller, each speaker, an AV decoder, or a main system. At this time, a communication unit capable of communicating direction information and calculated distance information with each other should be disposed. In the present embodiment, it is assumed that a communication protocol and apparatus exist already.

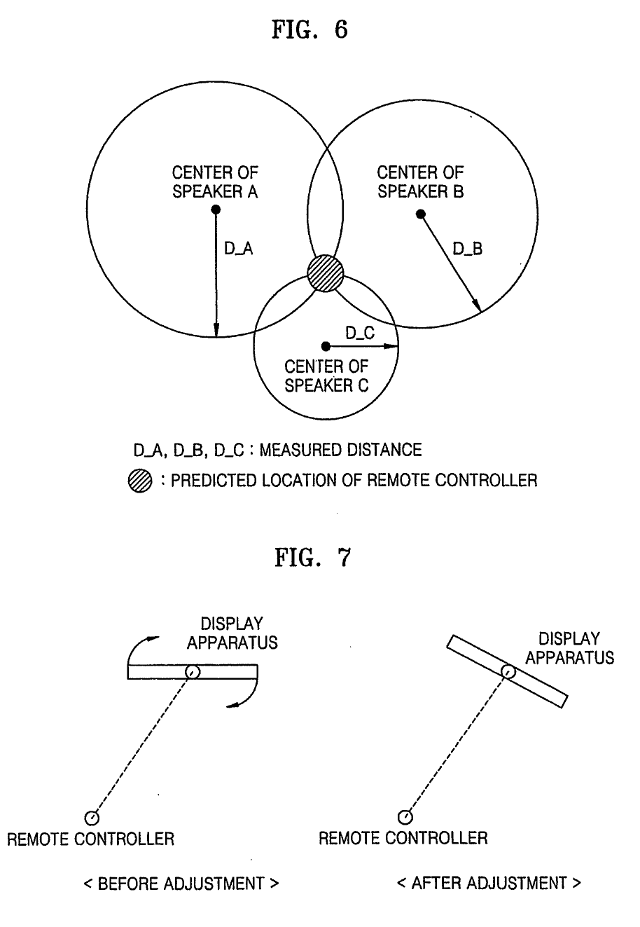

FIG. 6 is a diagram for explaining a method of calculating the direction when there is only a distance sensor according to another embodiment of the present invention. The direction sensor described with reference to FIG. 5 has a drawback in that it is difficult to obtain and the price is expensive. Accordingly, by using a distance sensor, the AV system can be tuned. Referring to FIG. 6, it is assumed that each speaker has a distance sensor. The function of the distance sensor is to calculate the distance to the remote controller. A signal transmission unit transmits a signal, and a time, t(sec), taken for detecting the signal returning from the remote controller is measured. Also, it is assumed that the velocity of a signal source is v (m/sec). In this case, the distance between the speaker and the remote controller is calculated by the following equation 2:

$$d = \frac{1}{2} \cdot t \cdot v \qquad ( 2 )$$

If the distance between each speaker and the remote controller is calculated, the direction is calculated according to the method shown in FIG. 6. That is, when circles having the distances calculated from the centers of at least three or more speakers, as radiuses, respectively, are drawn, the intersection of all the circles will determine the location of the remote controller. Then, if the center of each speaker is connected to the location of the remote controller, the direction between each speaker and the remote controller can be obtained. If the direction of each speaker and the remote controller is determined, the direction and volume of each speaker are adjusted according the method described above.

The above embodiments describe the tuning method for an AV System when each speaker performs sensing of the electronic apparatus such as the remote controller in order to identify the location of the user. Also, reversely, the electronic apparatus such as a remote controller can be a main unit. That is, such a method may include: an operation for turning on the power of a remote controller; an operation for sensing each speaker by the remote controller and obtaining the distance and direction of each speaker; an operation for adjusting the direction and volume of each speaker by transmitting indirectly or directly calculated distance and direction information to the speaker, or transmitting control information to adjust the direction and volume of the speaker according to distance and direction information; and repeating the above operations continuously as the location of the remote controller moves.

Meanwhile, a method of sensing the distance or direction can be performed in a variety of ways. That is, a variety of sensors, including an RFID sensor as well as a laser sensor, an infrared sensor, and an ultrasonic sensor can be used. For example, in the case of an RFID sensor, IDs are attached to each speaker and the remote controller and distance or direction calculators based on the sensor are attached to the speakers or the remote controller such that the operation described above can be performed.

Also, in the present invention, the remote controller is described as an apparatus that can be present nearest to the body of a user and can be recognized electronically. However, the present invention can be implemented by using an electronic apparatus including a distance or direction sensor as well as the remote controller. For example, the user can wear a badge as a simple sensing apparatus, and can use any electronic apparatus, such as a necklace and a wrist watch, that can be attached to the body of the user. In the future, a fine index tag based on an MEMS can be inserted into the human body in order to be used.

FIG. 7 is a diagram for explaining a method of sensing a remote controller and adjusting the direction of a display apparatus according to another embodiment of the present invention. Referring to FIG. 7, in order to adjust the angle of the TV screen with respect to the distance or direction of a display apparatus, such as a TV, to the user, the method described above can be used. That is, by sensing a remote controller, the screen of the display apparatus can also be adjusted. For convenience of explanation, a 2-dimensional adjustment is explained in FIG. 7, but it can be extended to a 3-dimenstional one.

The method of adjusting the screen of a display apparatus can be summarized as follows.
1) A user pushes a predetermined button of a remote controller.
2) Based on the same principle as described above with reference to FIG. 4, the distance and direction of the TV screen to the remote controller are calculated.
3) The TV screen is rotated so that the line connecting the remote controller and the center or the TV is perpendicular to the TV screen.

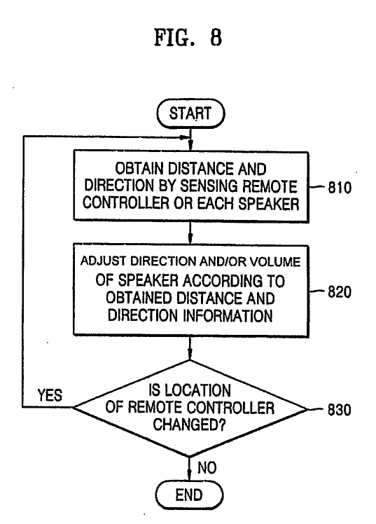

FIG. 8 is a flowchart of operations of a method of sensing the location of a user and tuning an AV system according to the present invention. Referring to FIG. 8, first, each speaker senses a remote controller and calculates the distance and direction of the speaker and the remote controller in operation 810 .Based on the calculated distance and direction information, the direction and volume of the speaker are adjusted so that optimum sound quality can be provided to the predicted location of the user in operation 820. The two operations are repeatedly performed when the location of the remote controller changes in operation 830.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

According to the present invention as described above, an AV system sensing the location of a user and providing optimum sound quality and a method of tuning the AV system are provided.

That is, through interaction between an electronic apparatus located near a user and an AV system, the location of a remote controller is accurately identified and the direction and volume of each speaker or display apparatus are adjusted so that optimum sound quality can be provided based on the location of the user.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A tuning method for an audio-visual (AV) system, comprising:
sensing the location of an electronic apparatus located within a predetermined distance from a user and calculating a direction and distance from the electronic apparatus to at least one speaker; and
adjusting a direction and volume of each speaker based on the sensed location of the electronic apparatus as the location of the user and based on the calculated direction and distance information of the electronics apparatus.

2. The method of claim 1, wherein the electronic apparatus is any apparatus that can be attached to the body of the user including a remote controller, a necklace, a wrist watch, a badge having a sensor, or an index tag having a sensor.

3. The method of claim 1, wherein the sensing is performed by any of a laser sensor, an infrared sensor, an ultrasound sensor, and a radio frequency identification (RFID) sensor.

4. The method of claim 1, wherein the calculating of the direction and distance comprises:
if a directional sensor is used, drawing virtual lines in the sensed direction from the center of each speaker, determining the intersection of the virtual lines as the location of the electronic apparatus, and calculating the distance.

5. The method of claim 1, wherein the calculating of the direction and distance comprises:
if a distance sensor is used, drawing circles having the centers of the speakers as respective circles centers and the sensed distances as respective radiuses, determining the intersection of all the circles as the location of the remote controller, and calculating the direction.

6. The method of claim 1, wherein in the adjusting of the direction and volume of each speaker, the direction of the speaker is adjusted to be perpendicular to the calculated direction, and based on the calculated distance, the volume is adjusted.

7. The method of claim 1, further comprising adjusting the direction of a display apparatus based on the calculated direction and distance information.

8. The method of claim 7, wherein in adjusting the direction of the display apparatus, the direction of the display apparatus is adjusted to be perpendicular to the calculated direction.

9. An AV(Audio Visual) system comprising:
at least one speaker to output decoded audio data;
an electronic apparatus,
a sensor to sense the location of the electronic apparatus; and
a control unit to adjust a direction and/or a volume of the speaker based upon the sensed location.

10. The system of claim 9, wherein the control unit comprises:
a distance and/or direction calculation unit to sense the electronic apparatus and to calculate the distance and/or direction to the speaker;
a direction and/or volume adjusting unit to adjust the direction and/or volume of the speaker by using the calculated distance and/or direction information.

11. The system of claim 9, wherein the electronic apparatus is any apparatus that can be attached to the body of the user, including any one of a remote controller, a necklace, a wrist watch, a badge having a sensor, and an index tag.

12. The system of claim 10, wherein the distance and/or direction calculation unit comprises any one of a laser sensor, an infrared sensor, an ultrasound sensor, and a radio frequency identification (RFID) sensor.

13. The system of claim 10, wherein if a directional sensor is used to sense the direction, the distance and/or direction calculation unit draws virtual lines in the sensed direction from the center of each speaker, determines the intersection of the virtual lines as the location of the electronic apparatus, and calculates the distance.

14. The system of claim 10, wherein if a distance sensor is used to sense the direction, the distance and/or direction calculation unit draws circles having the centers of the speakers as respective circles centers and the sensed distances as respective radiuses, determines the intersection of all the circles as the location of the remote controller, and calculates the direction.

15. The system of claim 10, wherein the direction adjusting unit adjusts the direction of the speaker to be perpendicular to the calculated direction.

16. The system of claim 15, wherein the direction adjusting unit adjusts the direction of a display apparatus to be perpendicular to the calculated direction based on the calculated direction information.

17. The system of claim 10, wherein the volume adjusting unit adjusts the volume of the speaker based on the calculated distance.

18. The system of claim 11, wherein the sensor based on an MEMS (Micro Electro Mechanical System).

19. A tuning method for an audio system, comprising:
calculating a distance and/or direction from an electronic apparatus to at least one speaker; and
adjusting a volume and/or direction of each speaker based on the calculated distance.

20. The method of claim 19, wherein the electronic apparatus has a sensor.
